(19) United States
(12) Patent Application Publication
(10) Pub. No.: US 2003/0138535 A1
(43) Pub. Date: Jul. 24, 2003

(54) Device for mechanically processing the surface of a piece of dough

(76) Inventors: Wilfried Barroche-Heinrich, Mitterdorf/Raab (AT); Peter Lambauer, Feldkirchen (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/312,297

(22) PCT Filed: Jul. 3, 2001
(86) PCT No.: PCT/AT01/00218

(30) Foreign Application Priority Data
Jul. 5, 2000 (AT) A 1156/2000

(51) Int. Cl. A21D 6/00

(52) U.S. Cl. 426/496

(57) ABSTRACT

An apparatus for mechanically processing the surface of a piece of dough comprises a pressure body (6) provided with at least one depression (5) for receiving the dough piece (3) to be processed that is put in by a put-in means (2) at a put-in location (4) into the depression (5). At a processing location (9) that is spatially offset with respect to the put-in location (4), a tool (20) is disposed in a framework (1) for up and down motion, which tool processes the dough piece (3) disposed within the depression (5). The processed dough pieces (3) are put off by the pressure body (6) at a delivery location (40) onto a rest means (33). The pressure body (6) is bearingly supported for rotation around its longitudinal axis on a pressure body carrier (42) separated from the put-in means (2). By the pressure body carrier (42), the pressure body (6) is displaceable to-and-fro between the put-in location (4) and the processing location (9). The delivery location (40) is disposed in the zone of this to-and-fro motion.

The invention relates to an apparatus for mechanically processing the surface of a piece of dough, comprising a pressure body provided with at least one depression for receiving the dough piece to be processed that is put in by a put-in means at a put-in location into the depression and is processed in the depression by a tool mounted for up and down motion in a framework at a processing location offset with respect to the put-in location, and a rest means onto which the processed dough piece is put by the pressure body at a delivering location, at which delivery the pressure body bearingly supported for pivotal motion around its longitudinal axis on a pressure body carrier separated from the put-in means is tilted at the delivering location, and the pressure body is to-and-fro displaceable by means of the pressure body carrier between the put-in location and the processing location.

Numerous kinds of rolls require a mechanical processing of the cover surface of a dough piece. Examples for this are stamping of Kaiser rolls or star rolls, producing of cuts in hard rolls, but also injecting into a dough piece and so on. For this, numerous apparatus are known. For processing, always a vertically movable tool carrier is used, under which a rest means carrying the dough pieces is disposed. This rest means can be a conveyor systems at which a plurality of pressure bodies is fixedly or exchangeably connected. A variant for this consists in that the pressure bodies are swivelably connected to the conveyor system (so-called turning pressure bodies), wherein the pressure bodies have two or more sides and each side shows a different shape of the pressure body. It is also known to dispose below the tool carrier swivelable pressure bodies having a plurality of sides, each side of the pressure body having the same shape. Further, it is known to form the rest means carrying the dough pieces as fermentation trolleys (for example tipping devices). Lastly, it is known to stamp the dough pieces carried by a conveyor belt.

Such apparatus which use a chain of pressure bodies have the disadvantage of a high effort and of a high space requirement. The high number of pressure bodies makes also cleaning expensively. A stamping operation in tipping devices, fermentation compartment hangers or even on a conveyor belt is not reliable in its result, because the dough pieces cannot be completely securely kept in position when they are stamped. Further, the always increasing roll assortment requires processing of the dough pieces in different manners, that means to make the apparatus variable with respect to the processing operation to be carried out. This requirement is not met by the known apparatus, or only by a high expenditure. This holds also for a known apparatus of the initially described kind (DE 18 11 392 A), in which the dough pieces are lifted from a dough bowl elevator and tipping device by means of a tongs-like lifting means forming the put-in means and are put into a kneading cup disposed above the tipping device. After kneading the dough piece this kneading cup is lowered and lastly tilted, so that the dough piece receives the dough bowl elevator and tipping device again. As an additional disadvantage, there occurs the tongs-like gripping the dough piece, because the dough piece either is only not reliably hold or is laterally squeezed, in particular when treating soft doughs.

The invention has at its object to improve an apparatus of the initially described kind so that the constructive and spatial effort is kept low, so that the first costs and the service costs for the apparatus are reduced. Further, there should be the possibility to adapt the apparatus in a simple manner to different kinds of rolls, and a gentle processing of the dough piece should be possible in the apparatus.

The invention solves this task by the feature that the delivering location is disposed in the zone of the to-and-fro motion. The dough piece that is inserted into the depression of the pressure body by the put-in means at the put-in location is conveyed by the pressure body after it has received the dough piece to the processing location at which by means of the tool the desired mechanical processing of the surface of the dough piece is performed, for example stamping or cutting, an injection or the like. As soon as this processing is completed, the pressure body carrier moves the pressure body back again into the put-in location. Over this distance of rearward motion, the processed dough piece is deposit onto the rest means by turning the pressure body around its longitudinal axis. This turn can be made still at the processing location, that means before starting the rearward motion of the pressure body carrier, however, it can also be performed at the put-in location only, whereby attention has only to be paid that putting-in of the following, still untreated dough piece does not interfere with the deposit of the already processed dough piece. Of course, the deposit of the processed dough piece can be made at any desired location between the two said locations. This makes the apparatus very flexible with respect to assembling with preceding or following apparatus. Whereas, for example, within a known apparatus the pressure bodies form an endless pressure body chain and, therefore, are moved always in the same direction, so that the delivering location must always be dislocated in this direction with respect to the put-in location and to the processing location, the invention offers the possibility to supply the dough pieces to be processed in any desired direction towards the pressure body and also to carry-off them in any desired direction from the delivering location. Thereby, space can be saved which not always and anywhere is unlimited at disposal. Further, the manner of transfer the processed dough piece from the pressure body onto the rest means can be influenced by corresponding control of the movement of the pressure body, what is not possible within a stepwisely revolving pressure body chain. The reduced expenditure of the inventive construction (in principle only one single pressure body is required) in comparison with a construction having a chain of pressure bodies is obvious.

Particularly of advantage is within the invention that the supplied dough piece must not be lifted in order to put it into the depression, but the put-in means can also serve for the supply of the dough piece. Particularly suitable for this are conveyor belts or a chain of pressure body hangers or a racking unit, whereby in all of these cases the dough piece can let falling down by a corresponding movement of the put-in means into the depression immediately disposed below, so that the dough piece receives the depression gently.

The reciprocating movement of the pressure body can be straight lined, for example by shifting it along a guide way. However, it is more favourable within the spirit of the invention if the pressure body carrier is constituted by an articulated lever pivotably supported around a horizontal axis in a framework, which lever carries on its one end the pressure body bearingly supported and on its other end is driven to a to-and-fro turn around the horizontal axis. This results in a simple construction having a low expenditure and enables one in a simple manner to vary the zone of dislocating the pressure body and, therefore, also the location of putting-in, of processing and of delivery, for example by adjusting the pivot location of the articulated lever at the framework and/or by varying the effective length of one or two arms of the articulated lever. According to a preferred embodiment, the movement of the articulated lever is made by articulating its lower end to the end of a connecting piece, the other end of which is articulated to an eccentric pin driven by a motor fixed to the framework.

Turning the pressure body around its longitudinal axis is suitably made by a motor which, according to a preferred embodiment of the invention, is also carried by the pressure body carrier. This is substantially more favourable than locating the motor at the framework, because in the latter case an expensive kinematics would be necessary for the transfer of the rotational motion to the pressure body. Suitably, within the spirit of the invention, the driven shaft of the motor is disposed coaxially to the rotational axis of the pressure body, if desired via a gear means. Thereby, a direct drive of the rotational axis of the pressure plate is obtained, which saves intermediate members between the driven shaft of the motor and this rotational axis.

According to a further embodiment of the invention, the pressure body comprises more than one depression, whereby the depressions are dislocated with respect to each other in rotational direction of the pressure body, preferably for equal angles. This enables one to put-off the processed dough piece out of its depression about simultaneously with putting-in the dough piece to be processed into the next depression, following in direction of rotation of the pressure body, so that the put-in location and the delivery location can be disposed at least substantially at the same location. Particularly suitable conditions are obtained if three depressions are disposed at the pressure body, distributed in peripheral direction of the pressure body, wherein these depressions may have the same shape and size, but must not. Namely, there is the possibility to give the depressions different shape and/or size in order to enable one to process different kinds of dough pieces. For example, stamping of Kaiser rolls can be performed within the first depression, stamping of star rolls by using the second depression and performing of cuts into the dough pieces for long shaped hard rolls using the third depression.

For bigger plants it is to be recommended that the pressure body carries rows of depressions extending in its longitudinal direction, wherein it is suitable to make the depressions of each row equal to each other.

As already mentioned, it is desired due to the always increasing assortment of rolls, to obtain a high versatility of the apparatus. For this, the invention offers the possibility in a simple manner, to perform the pressure body as an easily exchangeable member, wherein the several pressure bodies have depressions of different shape and/or size. Also, there is the possibility within the spirit of the invention, to mount a plurality of different tools on a common tool carrier, for example on a turret head, wherein only the desired tool is brought into an operation position. The variation range can still be increased if each tool constitutes an easily exchangeable member, so that for each tool holding means a plurality of different tools is at disposal.

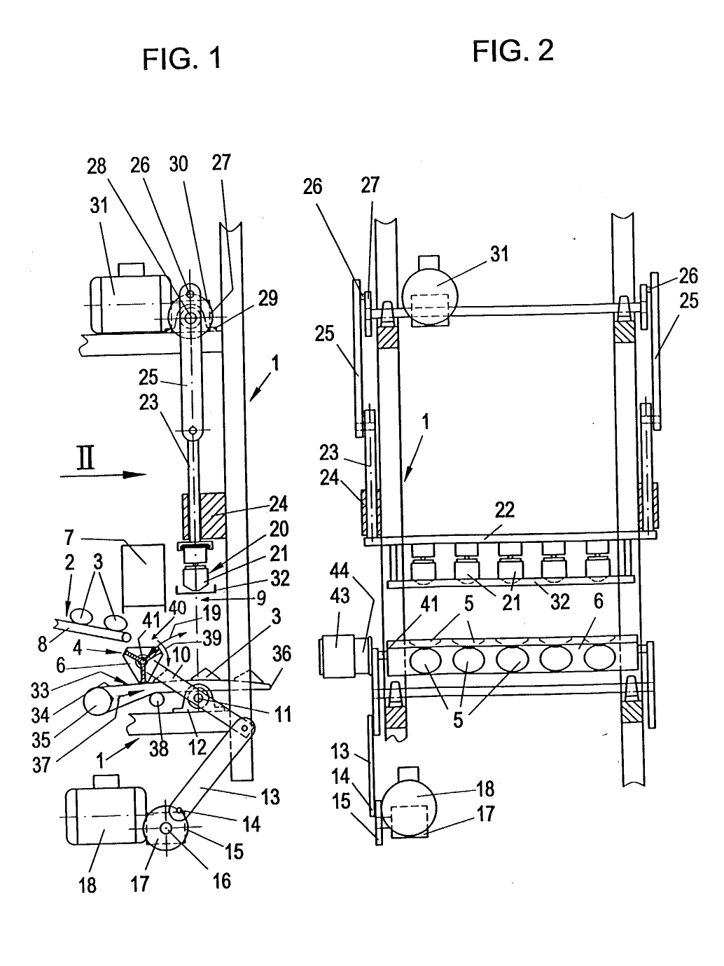

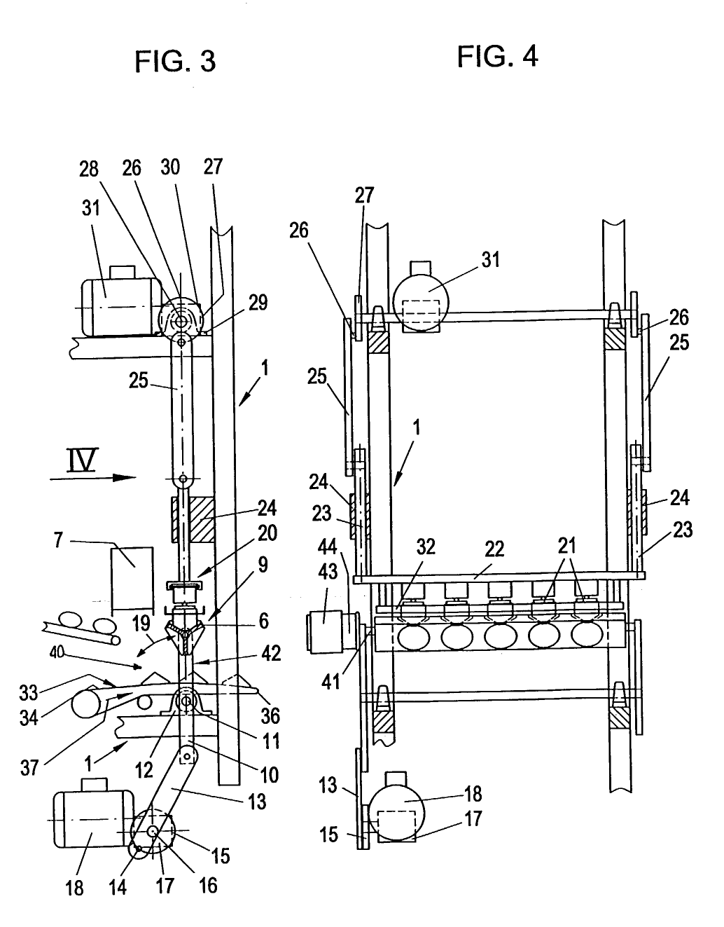

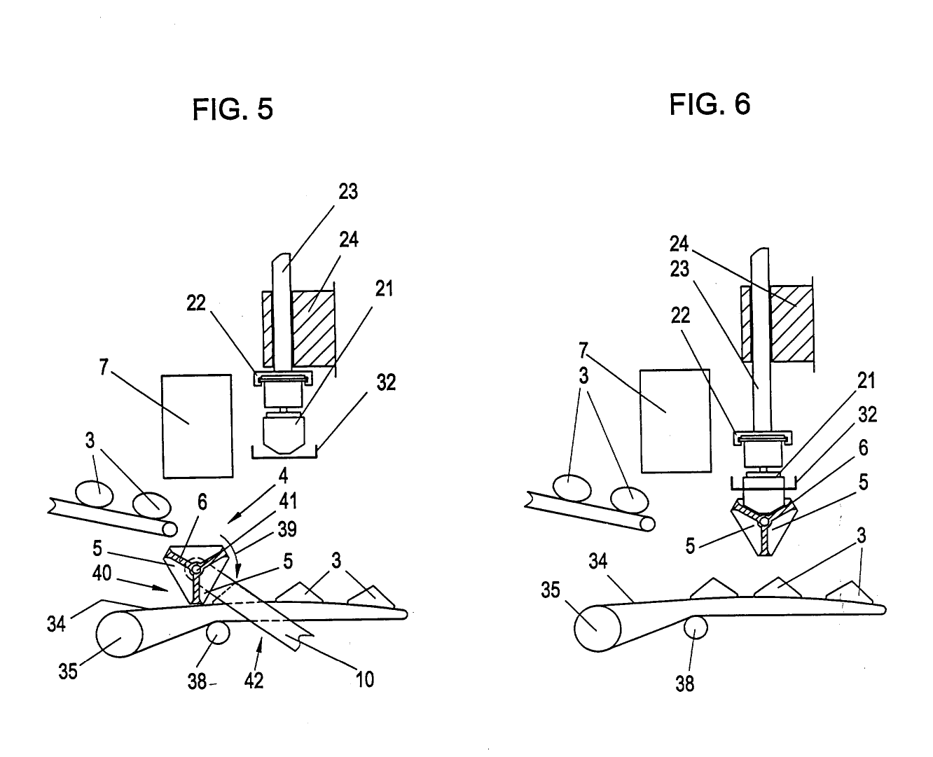

Further features and advantages of the invention can be seen from the description of an embodiment example, which is schematically shown in the drawing. FIG. 1 shows the apparatus in a view seen from the side, and this with its pressure body in the put-in position. FIG. 2 is a view seen in direction of the arrow 11 of FIG. 1. FIG. 3 shows a side view similar to FIG. 1, however, the pressure body being in the processing position. FIG. 4 is a view seen in direction of the arrow IV of FIG. 3. FIG. 5 shows in an enlarged scale the conditions at the put-in location with the pressure body being in the put-in position, whereas FIG. 6, also in an enlarged scale, shows the conditions when the pressure body is in the processing position.

The apparatus has a framework 1, only partially shown, in which a put-in means 2 is disposed which supplies the suitably somewhat pre-proofed dough pieces 3 to a put-in location at which dough piece after dough piece is put-in into a depression 5 (FIG. 2) of a pressure body 6. Suitably, the put-in means 2 is formed by an endless conveyor belt 8, however, the put-in means 2 can also be formed by a chain of hangers having depressions or by a racking band or the like. As it can be seen, the delivery end of the put-in means 2 is disposed close above the pressure body 6 being in the put-in location 4, so that the respective dough piece is gently let fallen from the put-in means into the pressure body 6 disposed below it. The supply of the dough pieces 3 can be made stepwisely or continuously. Immediately above the put-in location 4 a flour-covering means 7 is disposed which flours the depression 5 of the pressure body 6 before the dough piece 3 is put-in or flours the dough piece 3 after its insertion into the depression 5 at its upper side. This flouring of the pressure body or of the dough piece is controllable in its amount, depending from the baking product desired. This flouring can be omitted if no flour is necessary for shaping the dough piece.

Suitably, the pressure cup 6 is elongated and is provided over its length with a plurality of depressions 5 (FIG. 2) being shaped equal to each other, in the embodiment shown there are five depressions. In an analogous manner, the dough pieces 3 are supplied in rows of five pieces each by the put-in means 2.

As soon as the dough pieces are inserted into the depressions 5 which, if desired, have been floured, the pressure body 6 is swung into the processing location 9 (FIGS. 3, 4, 6). For this, the pressure body 6 is fixed to the one end of a double lever 10 which is articulated in its middle zone for rotation around an axis 11 which is disposed at a pillow block 12 of the framework 1. The other end of the double lever 10 is articulated to the one end of a connecting piece 13, the other end of which is articulated to an eccentric pin 14. This eccentric pin 14 is disposed eccentrically on a disk 15 mounted on a shaft 16 which is driven for rotation by a motor 18 via a controllable gear means 17. Therefore, swinging of the pressure body 6 from the put-in location (FIGS. 1, 5) into the processing location (FIG. 3, 6) is done in the clockwise sense in direction of the double arrow 19 around the axis 11 and this so long until the pressure body 6 has reached a position below a tool 20 which is disposed at the processing location 9 and can be moved up and down. In the embodiment shown, the tool 20 is formed by one stamping head 21 per depression 5 of the pressure body 6. Each stamping head is easily exchangeable fixed to a tool holding means 22 which can be moved vertically in the framework 1. For this, the tool holding means 22 is fixed to two rods 23, each of which being vertically shiftable in a slide guidance 24 of the framework 1. Each rod 23 is articulated at its upper end to the one end of a connecting piece 25, the other end of which is articulately connected to an eccentric pin 26 that is mounted eccentrically on a disk 27 fixed to a shaft 28. The shaft 28 is bearingly supported for rotation in a pillow block 29 of the framework 1 and is driven for rotational movement via a controllable gear means 30 by a motor 31.

The pressure body 6 remains in the processing location by a corresponding stop of the motor 18 until the processing operation has been terminated. Within this processing operation, which in the embodiment shown is a stamping operation, for example for Kaiser rolls, the tools 20 are dislocated vertically downward by a corresponding control of the motor 31, as soon as the pressure body 6 has reached the processing location. The processing tools, in the embodiment shown the stamping heads 21, press now their pattern into the dough pieces disposed within the depressions 5. The lowermost position of the tools 20 is shown in FIGS. 3 and 6. It corresponds to the lowermost position of the eccentric pin 26. Then, the rods 23 and the tool holding means connected to them are lifted again by the upward movement of the eccentric pin 26, however, the dough pieces remain within the depressions 5 of the pressure body 6. This can be assisted by a stripper 32.

As soon as processing of the dough pieces 3 is terminated and the tools 20 have been sufficiently lifted, the motor 18 is fed again so that it swings the articulated lever 10 so that the pressure body 6 is brought back into the put-in location 2 in direction of the double arrow 19. As soon as the position at the put-in location 4 has been reached, or already during the transport from the processing location 9 to the put-in location 4, the dough pieces 3 are put off the depressions 5 of the pressure body 6 and reach thereby a rest means 30 which in the embodiment shown is formed by an endless conveyor belt 34 that is guided around a deflection roller 35 and a deposition edge 36 and circulates in direction of the arrow 37. In addition, a tensioning roller 38 may be provided. This deposition of the dough pieces is made by rotation or tilting the pressure body around its longitudinal axis so that the dough pieces fall out of the depressions 5 and onto the conveyor belt 34 disposed below. As it can be seen, this conveyor belt is formed as a transfer band, it may move step by step or continuously. In the embodiment shown, the dough pieces 3 are conveyed off to the right, however, the direction of conveying off can also be made to the left, if the conveyor belt 34 is correspondingly driven and disposed. Therefore, the construction is free with respect to conveying the dough pieces. Instead of a conveyor belt 34 as a rest means, this can be also formed by a racking belt, a fermentation trolley, baking sheets or the like.

As it can be seen, the pressure body 6 has three rows of depressions 5, dislocated with respect to each other for 120°. Therefore, if the processed dough pieces are released from a depression row by swivelling the pressure body 6 in direction of the arrow 39 (FIG. 5), simultaneously the next depression roll can be filled by means of the put-in means 2, if the delivering location 40 (FIG. 5) coincides with the put-in location 4. However, as already mentioned, delivery of the dough pieces by rotation of the pressure body 6 can be performed in the entire region between the processing location 9 and the put-in location 4. Therefore, the delivering location 40 is disposed between the processing location 9 and the put-in location 4, these two positions included.

The pressure body 6 is mounted for rotation around an axis 41 on a pressure body carrier 42 that is formed by the articulated lever 10. This pressure body carrier carries also a motor 43 having a controllable gear means 44 (FIG. 2), the driven shaft of which coincides with the axis 41. In the moment suitable for the necessary rotation of the pressure body 6, the motor 43 is fed by control means, not shown, which control means also serves for feeding the motors 18, 31.

The pressure body 6 must not have three rows of depressions 5, also two such rows may be sufficient. If desired, also one single row of depressions 5 may be sufficient, if the pressure body 6 after terminating the stamping process or the like is at first rotated for dropping the readily processed dough pieces and then is rotated back or further rotated into the put-in position.

The rotation of the pressure body 6 must not be made in a clockwise sense (arrow 39), a rotation in an anti-clockwise sense is also possible at the shown position of the pressure body 6 in its delivery position closely above the conveyor belt 34, if the conveyor belt 34 is moved to the left. The direction of movement of the conveyor belt 34 is immaterial, if the delivery position of the pressure body 6 is disposed so much above the upper run of the conveyor belt 34 that the dough pieces 3 can run below the pressure body 6. Generally, however, a small height of fall of the dough pieces is desired in order to avoid undesired deformations of the dough pieces.

In the most simple case, the tool holding means 22 may be a carrier plate to which one or more tools 20 are fixedly mounted or to which exchangeable tools are connected so that one can change from a processing manner to another processing manner by a simple exchange of the tools. Suitable take-up means having quick-fitting couplings or the like are at disposal. The tool holding means can also be formed by a rotatable revolver head which carries a plurality of fixedly mounted tools showing to different directions, or carrying also exchangeably mounted tools.

The variation possibilities with regard to processing the dough pieces can be increased by giving the depressions disposed at the pressure body 6 different shapes and, respectively, or sizes, however, suitably the depressions are equal to each other in each row of depressions. Further, it is possible that the pressure body 6 forms an easily exchangeably member, for example by providing the axis 41 by which the pressure body 6 is articulated to the pressure body carrier 42, with quick-fitting couplings.

Also the flour-covering means 7 can be driven for delivery of flour in time with filling the depressions 5 of the pressure body 6, for example by a rotating brush disposed in the flour-covering means 7.

The pressure body carrier 42 must not be formed by a swivelable lever, because the pressure body 6 can also be moved by a suitable drive means along a guide means of the framework 1 between its several positions (put-in location 4, processing location 9, delivering location 40), also translational, that means straight-lined. Also it is possible to guide a swivelable lever forming the pressure body carrier 42 by means of a roller along a curved path and to use the thereby created movement of the articulated lever also for the motion of the tool holding means 22 by a mechanical coupling.

1. Apparatus for mechanically processing the surface of a piece of dough, comprising a pressure body (6) provided with at least one depression (5) for receiving the dough piece (3) to be processed that is put in by a put-in means (2) at a put-in location (4) into the depression (5) and is processed in the depression (5) by a tool (20) mounted for up and down motion in a framework (1) at a processing location (9) offset with respect to the put-in location (4), and a rest means (33) onto which the processed dough piece (3) is put by the pressure body (6) at a delivering location (40) at which delivery the pressure body (6) bearingly supported for pivotal motion around its longitudinal axis (41) on a pressure body carrier (42) separated from the put-in means (2) is tilted at the delivering location (40), and the pressure body (6) is to-and-fro displaceable by means of the pressure body carrier (42) between the put-in location (4) and the processing location (9), characterised in that the delivering location (40) is disposed in the zone of the to-and-fro motion.

2. Apparatus according to claim 1, characterised in that the put-in means (2) is constituted by a conveyor belt (8) or by a chain of pressure body hangers or by a racking unit.

3. Apparatus according to claim 1 or 2, characterised in that the pressure body carrier (42) is constituted by an articulated lever (10) pivotably supported around a horizontal axis (11) in a framework (1), which lever carries on its one end the pressure body (6) bearingly supported and on its other end is driven to a to-and-fro turn around the horizontal axis (11).

4. Apparatus according to claim 3, characterised in that the lower end of the articulated lever (10) is articulated to an end of a connecting piece (13), the other end of which is articulated to an eccentric pin (14) driven by a motor (18) fixed to the framework (1).

5. Apparatus according to any of claims 1 to 4, characterised in that the pressure body carrier (42) carries also a motor (43) for turning the pressure body (6).

6. Apparatus according to claim 5, characterised in that the driven shaft of the motor (43) is disposed coaxially to the rotational axis (41) of the pressure body, if desired via a gear means (44).

7. Apparatus according to any of claims 1 to 6, characterised in that the pressure body (6) comprises more than one depression (5), whereby the depressions are dislocated with respect to each other in peripheral direction of the pressure body (6), preferably for equal angles.

8. Apparatus according to claim 7, characterised in that the depressions (5) have different shape and, respectively, or size.

9. Apparatus according to any of claims 1 to 8, characterised in that the pressure body (6) carries rows of depressions (5) extending in its longitudinal direction.

10. Apparatus according to any of claims 1 to 9, characterised in that the pressure body (6) constitutes an easily exchangeable member.

11. Apparatus according to any of claims 1 to 10, characterised in that a plurality of interchangeable tools are mounted on a common tool carrier (22), for example on a turret head.

12. Apparatus according to any of claims 1 to 11, characterised in that each tool constitutes an easily exchangeable member.
